(19) United States
(12) Patent Application Publication
(10) Pub. No.: US 2018/0210477 A1
(43) Pub. Date: Jul. 26, 2018

(54) DIRECT VOLTAGE - DIRECT CURRENT CONVERTER CONTROL CIRCUIT

(71) Applicant: Closed-up joint-stock company DRIVE, Novosibirsk (RU)

(72) Inventors: Yuriy I. Romanov, Novosibirsk (RU); Stanislav V. Maletskiy, Novosibirsk (RU)

(21) Appl. No.: 15/745,419

(22) PCT Filed: Jul. 17, 2015
(86) PCT No.: PCT/RU2015/000457

§ 371 Date: Jan. 16, 2018

(51) Int. Cl. G05F 1/46; G05F 1/575; H02M 3/156

(52) U.S. Cl. CPC G05F 1/461; H02M 2001/0003; H02M 3/156; G05F 1/575

(57) ABSTRACT

A control circuit for a direct voltage—direct current converter comprising an operational amplifier 1, a feedback element 40 and a bias direct voltage source 7 at an input of the operational amplifier 1. The control circuit provides the separation of the bias voltage from the feedback signal thus resulting in decreasing watt consumption in the converter.

### REFERENCE TO RELATED APPLICATION

This application is a U.S. National phase continuation-in-part application of International application PCT/RU2015/000457 filed on Jul. 17, 2015 and incorporated hereby by reference in its entirety.

### FIELD OF THE DISCLOSURE

The proposed design relates to electrical engineering and can be used for controlling direct voltage—direct current converters to lower watt consumption.

### DESCRIPTION OF THE RELATED ART

There have been known comparable designs, see, for example, http://radiobooksa.ru/radionach/163-regulyatory-napryazbenuiya-i-toka.html- A. G. Alexenko et al.“Application of precision analog IC”, Moscow, Radio i Svyaz, 1981, p. 148, Table 6.2a, where a direct voltage—direct current converter controlling circuit is presented which comprises:
an operational amplifier connected by an inverting (“−”) input thereof to an output of a setter of output current of a direct voltage—direct current converter, by a non-inverting (“+”) input thereof to an output of the direct voltage—direct current converter, and by an output thereof to a control input of the direct voltage—direct current converter.

A common feature of the proposed design and the above-characterized design is the operational amplifier connected by the output thereof to the control input of the direct voltage—direct current converter.

Also known is a comparable design, see “Electronic Circuits: Handbook for Design and Application”, by U. Tietze and C. Schenk, Moscow, “Mir”, 1982, FIG. 12.11a, where a direct voltage—direct current converter control circuit is shown, the circuit being selected as the closest analog—prototype—comprising:
an operational amplifier connected by its non-inverting (“+”) input to an output of a setter of output current of a direct voltage—direct current converter, by its inverting (“−“) input—to an output of the direct voltage—direct current converter (to a terminal of a measuring resistor), and by its output—to a control input of the direct voltage—direct current converter.

Common features of the proposed design and the design-prototype are:
the operational amplifier connected by its non-inverting (”+“) input to the output of the setter of the output current of the direct voltage—direct current converter and by its output to the control input of the direct voltage—direct current converter.

The technical result, which cannot be achieved by either of the above-described designs, lies in lowering watt consumption of the direct current flowing through the direct voltage—direct current converter. The reason why this technical result cannot be achieved is that—in prior art designs—direct current flowing through the direct voltage—direct current converter applies not only feedback voltage from a terminal of the measuring resistor to the inverting (”−“) input of the operational amplifier but also applies bias direct voltage to the inverting (”−“) input of the operational amplifier, which voltage is substantially large for conventional operational amplifiers, and this results in substantial power consumption.

With the above-discussed features and qualities of the prior art designs in view, one can conclude that the object providing a control circuit for a direct voltage—direct current converter securing insignificant power consumption is a relevant one to this day.

### SUMMARY OF THE INVENTION

The above-identified technical result is achieved by providing a direct voltage—direct current converter control circuit comprising an operational amplifier connected by its non-inverting (”+“) input to an output of a setter of output current of the direct voltage—direct current converter (a first input of the control circuit) and by its output—to a control input of the direct voltage—direct current converter, and is also provided with a feedback element (including, for example, a fixed-value resistor), a reference resistor and a source of direct voltage. An input of the feedback element is a second input of the control circuit, whereas connected to an inverting (”−“) input of the operational amplifier are an output of the feedback element and, connected in series, the reference resistor and the source of direct voltage.

The above-described implementation of the circuit controlling the direct voltage—direct current converter makes it possible, at applying direct voltage to the direct voltage—direct current converter, to eventually convert the input direct voltage into a unvarying direct current whose value depends on the voltage at the first input of the control circuit (in other words, on the voltage of the setter of the output current of the direct voltage—direct current converter).

As output current flows through the measuring resistor of the direct voltage—direct current converter, a voltage drop appears across the measuring resistor which, as a feedback voltage is applied to the second input of the control circuit (at the input of the feedback element), and via the feedback element this voltage is applied to the inverting (”−“) input of the operational amplifier of the direct voltage—direct current converter control circuit.

At the same time, a bias voltage making the operation mode of the operational amplifier possible is applied through a reference resistor to the same inverting (”−“) input of the operational amplifier from a source of direct voltage of the direct voltage—direct current converter control circuit. In practice, this bias voltage does not depend on the value of either the output current or the measuring resistor. Under the feedback voltage applied from the output of the feedback element to the inverting (”−“) input of the operational amplifier, the output current of the direct voltage—direct current converter becomes stabilized at the level which is defined by the voltage applied to the non-inverting (”+“) input of the operational amplifier from the first input of the control circuit (from the output of the setter of the output current of the direct voltage—direct current converter).

Thus, in the proposed design, unlike the prototype, forming the bias voltage at the inverting (”−“) input of the operational amplifier, which makes the operation mode of the operational amplifier possible, is not related to forming the feedback voltage stabilizing the output current value at a set level. As a result, a reasonably small value of the measuring resistor can be chosen, and, thus, the power consumed by the direct voltage—direct current converter can be substantially reduced.

This can be illustrated by trivial calculations.

Suppose that the required bias voltage U_{bias} at the inverting (”−“) input of the operational amplifier (the voltage which makes the operation mode of the operational amplifier possible) is U_{bias}=2.0 V. Suppose that three values of the output current of the regulator of the direct current flowing through the load should be stabilized: Iₒᵤₜ=0.1 A, 1.0 A, and 10.0 A.

For the prototype, to form the bias voltage equal to 2.0 V with the current of 0.1 A, the value Rₘₛᵣ of the measuring resistor will be Rₘₛᵣ=U_{bias}/Iₒᵤₜ=2.0:0.1=20 Ohm.

Then, the consumed power for the prototype, Pₚₜₜ, at the current of 0.1 A will be

Pₚₜₜ=Iₒᵤₜ²·Rₘₛᵣ=0.1²·20=0.2 Wt.

At the prototype, to form the bias voltage equal to 2.0 V with the current of 1.0 A, the value Rₘₛᵣ of the measuring resistor will be Rₘₛᵣ=U_{bias}/Iₒᵤₜ=2.0:1.0=2.0 Ohm.

Then, the consumed power, Pₚₜₜ, at the current of 1.0 A will be

Pₚₜₜ=Iₒᵤₜ²·Rₘₛᵣ=1.0²·2.0=2 Wt.

And at the current of 10 A, the value Rₘₛᵣ of the measuring resistor for the prototype is Rₘₛᵣ=U_{bias}/Iₒᵤₜ=2.0:10.0=0.2 Ohm, the consumed power, Pₚₜₜ, at the current of 10.0 A being:

Pₚₜₜ=Iₒᵤₜ²·Rₘₛᵣ=10.0²0.2=20 Wt.

In the proposed design, to the contrary, the value of the measuring resistor can be chosen arbitrary small, for example, 0.1 Ohm, without regard to the required bias voltage.

Then, with the current of 0.1 A, the power consumed across the measuring resistor in the proposed design will be

P_{propdes}=Iₒᵤₜ²·Rₘₛᵣ=0.1²0.1=0.001 Wt.

With the current of 1.0 A, the power consumed across the measuring resistor in the proposed design will be

P_{propdes}=Iₒᵤₜ²·Rₘₛᵣ=1.0²0.1=0.1 Wt.

With the current of 10.0 A, the power consumed across the measuring resistor in the proposed design will be

P_{propdes}=Iₒᵤₜ²·Rₘₛᵣ=10.0²0.1=10 Wt.

That being said, it is noted that additional power in the proposed design is dissipated in the feedback element and in the direct voltage source. Assume that the feedback element is a resistor of R_{fe}=3.9 kOhm, which in practice secures reliable operation of the apparatus made in accordance with the proposed design.
Then, consumed power in the feedback element will be

P_{fe}=U_{bias}²/R_{fe}=0.4²:3900=0.00004 Wt.

Consumed power of the direct voltage source in the proposed design is of about the same value. Adding these values to those calculated in the above and presenting the results in the comparison table will show the following:

TABLE
Summarized calculations

| | | Consumed | Consumed | Consumed |
|---|---|---|---|---|
| | | power in the | power in the | power |
| | Output current of the | prototype, | proposed | gain, |
| No | direct current regulator, A | Wt., | design, Wt. | times |
| 1 | 0.1 | 0.2 | 0.00108 | ~200 |
| 2 | 1.0 | 2.0 | 0.10008 | ~20 |
| 3 | 10.0 | 20 | 10.00008 | ~2 |

It follows from the table that the gain in times in consumed power can top scores and hundreds. Those skilled in the art would appreciate that the bias voltage U_{bias} at the inverting (”−“) input of the operational amplifier, securing its operation mode, can be, depending on the type of the operational amplifier, 0.4 V or 1.0 V or 4.0 V, and higher;

output current of the direct voltage—direct current converter can be from the very few milliamperes up to scores amperes. In all these given cases, the right choice of the measuring resistor, feedback element, and control voltage source in the proposed design makes it possible to reduce consumed power as compared with the prototype by a factor of scores and even hundreds. It is there where the above-mentioned technical result shows.

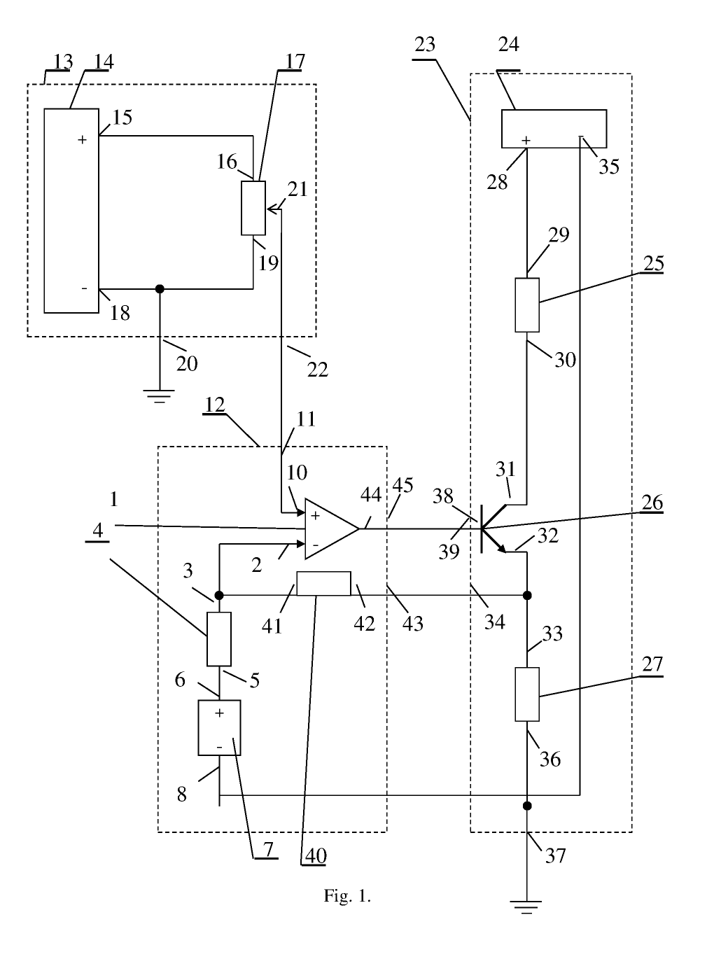

The operation of the proposed direct voltage—direct current converter control circuit is explained below with reference to the drawing of FIG. 1, which illustrates an example of implementation of a control circuit for a direct voltage—direct current converter incorporated into a regulator of direct current. Presented in FIG. 1 are:

an operational amplifier 1 connected by its inverting (”−“) input 2 to a first terminal 3 of a reference resistor 4 connected by its second terminal 5 to a positive terminal 6 of a first direct voltage source 7 connected by its negative terminal 8 via an output 20 to a common wire, the non-inverting (”+“) input 10 of the operational amplifier 1 being a first input 11 of the direct voltage—direct current converter control circuit 12;

a setter 13 of the value of the output current of the direct voltage—direct current converter, made, for example, as a second direct voltage source 14 and connected by its positive terminal 15 to one, 16, of the terminals of a variable resistor 17, and by its negative terminal 18—to another terminal 19 of the variable resistor 17, and—via a terminal 20—to the common wire. The variable resistor 17 is connected by its output (slider) 21 to an output 22 of the setter 13 of the output current of the direct voltage—direct current converter, which is connected to the first input 11 of the direct voltage—direct current converter control circuit 12;

a direct voltage—direct current converter 23 made, for example, as a third direct voltage source 24, a load 25, a bipolar transistor 26 and, a measuring resistor 27. At that, a positive terminal 28 of the third direct voltage source 24 is connected to a first terminal 29 of the load 25, a second terminal 30 of the load 25 is connected to the collector 31 of the bipolar transistor 26, the emitter 32 of the bipolar transistor 26 is connected to a first terminal 33 of the measuring resistor 27 and to a first output 34 of the direct voltage—direct current converter 23, a negative terminal 35 of the third direct voltage source 24 is connected to a second terminal 36 of the measuring resistor 27 and, via a terminal 37, which is a second output of the direct voltage—direct current converter 23, is connected to the common wire 20, whereas the base 38 of the bipolar transistor 26 is a control input 39 of the direct voltage direct current converter 23;

a feedback element 40, including, for example, a resistor, with a first terminal 41 thereof connected to the inverting (”−“) input 2 of the operating amplifier 1 and with a second terminal 42 thereof representing a second input 43 of the control circuit 12 of the direct voltage—direct current converter 23 and connected to the output 34 of the direct voltage—direct current converter 23, an output 44 of the operational amplifier 1 being an output 45 of the control circuit 12 of the direct voltage—direct current converter 23.

The proposed circuit controlling the direct voltage—direct current converter operates, when incorporated into the regulator of direct current flowing through the load, as follows.

Applied from the output 22 of the setter 13 of output current of the direct voltage—direct current converter 23 to the first input 11 of the direct voltage—direct current converter 23 control circuit 12 (to the non-inverting (”+“) input 10 of the operational amplifier 1) is a voltage required for producing current of a preset value flowing through the load 25.

This voltage can be obtained, for example, by providing a second source 14 of direct voltage and the variable resistor 17 connected through its terminals 16 and 19 between the positive 15 and negative 18 terminals of the second source 14 of direct voltage, respectively. From the output (slider) 21 of the variable resistor 17, the required control voltage is applied to the output 22 of the setter 13 of output current of the direct voltage—direct current converter 23.

The preset value of the direct current is stabilized due to the feedback involving the operational amplifier 1, bipolar transistor 26, measuring resistor 27 and feedback element 40. Indeed, when the direct current flowing in the circuit including the positive terminal 28 of the third direct voltage source 24—load 25—bipolar transistor 26—measuring resistor 27 decreases in comparison with the preset value (because of, for example, the increase of the load 25 resistance), a decreasing voltage arrives from the output 34 of the direct voltage—direct current converter 23 at the second input 43 of the direct voltage direct current converter 23 control circuit 12. Through the feedback element 40, this voltage arrives at the inverting (”−“) input 2 of the operational amplifier 1. Coming at the other, non-inverting (”+“) input 10 of the operational amplifier 1 is the control voltage from the output 22 of the setter 13 of the output current of the direct voltage—direct current converter 23.

The decrease of the voltage at the inverting (”−“) input 2 of the operational amplifier 1 results in a voltage difference between the inputs of the operational amplifier 1 and, thus, to the increase of the voltage at its output 44 which, through the output 45 of the direct voltage—direct current converter 23 control circuit 12, is applied to the base 38 of the bipolar transistor 26. Consequently, the bipolar transistor opens, and the current through the transistor increases which compensates for the initial decrease of the direct current in the above-identified circuit.

Should the direct current flowing in the above-identified circuit increases, the above-described processes repeat themselves with the opposite sign, also resulting in the compensation of the initial direct current variation.

Therefore, the current will flow through the measuring resistor 27, which will be independent of load 25 variations, the value of the current being defined by the value of the measuring resistor 27 and the output voltage of the setter 13 of output current of the direct voltage—direct current converter 23. In this case, if the output voltage of the setter 13 of output current of the direct voltage direct current converter 23 connected to the non-inverting (”+“) input 10 of the operational amplifier 1 of the control circuit 12 of the direct voltage—direct current converter 23 is higher that the voltage at the inverting (”−“) input 2 of the operational amplifier 1 connected to the emitter 32 of the bipolar transistor 26 and to the measuring resistor 27 of the direct voltage—direct current converter 23 via the feedback element 40, then applied to the output 44 of the operational amplifier 1 connected to the base 38 of the bipolar transistor 26 will be such a voltage that the bipolar transistor 26 opens, and the voltage across the measuring resistor 27 will be increasing up to the moment when the voltage at the inverting (”—“) input 2 of the operational amplifier 1 reaches the value of the output voltage of the setter 13 of output current of the direct voltage—direct current converter 23.

At this moment, the voltage at the output 44 of the operational amplifier 1 will stop rising, the voltage at the emitter 32 of the bipolar transistor 26 will stop rising as well and will be of such value where the voltage at the point of connection of the emitter 32 of the bipolar transistor 26 and the measuring resistor 27 will be equal to the voltage at the non-inverting (”+“) input 10 of the operational amplifier 1 (taking into account the voltage drop at the feedback element 40, as well as the voltage at the first terminal 3 of the reference resistor 4 connected by its second terminal 5 to the positive terminal 6 of the first source 7 of the direct voltage), and this state will be maintained under variations of the load 25.

Consequently, as the value of the load 25 varies, the direct current flowing therethrough will be stabilized, and its value is defined by the value of the output voltage of the setter 13 of output current of the direct voltage direct current converter 23 and the value of the measuring resistor 27.

This being said, the operation mode of the operational amplifier 1 of the direct voltage—direct current converter control circuit 12 is defined by the bias voltage coming from the terminal 6 of the first direct voltage source 7 via the reference resistor 4 to the inverting (”−“) input 2 of the operational amplifier 1. Due to that, the value of the measuring resistor 27 can be chosen small enough, no matter of what the value of the required bias voltage is, therefore the resistor dissipation power also becomes small enough.

As a result, the proposed control circuit 12 of the direct voltage—direct current converter 23 makes it possible, due to the separate forming of the bias voltage at the inverting (”−“) input 2 of the operational amplifier 1 and of the feedback voltage coming via the feedback element 40 to the same input, to dramatically decrease watt consumption.

It is to be noted that the proposed design can be implemented in many ways. For example, the transistor 26 can be not only a bipolar one, but also a MOS transistor, an IGBT, and in fact any linear controlling element.

The output voltage of the setter 13 of output current of the direct voltage—direct current converter 23 can also be formed in different ways, as compared with the above-disclosed manner, such as converting pulse-width modulation into the control voltage, or converting the code of a controlling protocol (DALI, for example) into the control voltage, or any other control action—control voltage conversion.

A common power circuit can be used to supply the setter 13 of output current of the direct voltage—direct current converter 23 and to establish the first direct voltage source 7. A current source made, for example, with the use of IC LT 3092, can function as the reference resistor 4, and so on.

All these various ways of implementing the proposed design ultimately yield the same technical result—decreasing the watt consumption through the separate forming of the bias voltage (at the inverting input of the operational amplifier) and of the feedback voltage (coming from the measuring resistor via the feedback element to the same input).

1. (canceled)

2. A direct voltage—direct current converter control circuit comprising an operational amplifier, a feedback element, a direct voltage source, and a reference resistor, a non-inverting input of the operational amplifier being a first input of the control circuit, an input of the feedback element being a second input of the control circuit, an inverting input of the operational amplifier being connected to an output of the feedback element and to connected in series the reference resistor and the direct voltage source, an output of the operational amplifier being an output of the control circuit.

3. The control circuit as claimed in claim 2, wherein the reference resistor includes a current source.
